(19) United States
(12) Patent Application Publication
(10) Pub. No.: US 2018/0107855 A1
(43) Pub. Date: Apr. 19, 2018

(54) FINGERPRINT SENSOR HAVING ROTATION GESTURE FUNCTIONALITY

(71) Applicant: PREH GMBH, Bad Neustadt a.d. Saale (DE)

(72) Inventor: Martin ERNST, Bad Königshofen (DE)

(73) Assignee: PREH GMBH, Bad Neustadt a. d. Saale (DE)

(21) Appl. No.: 15/718,446

(22) Filed: Sep. 28, 2017

(30) Foreign Application Priority Data
Oct. 18, 2016 (DE) 10 2016 119 844.7

(51) Int. Cl. G06K 9/00; B62D 1/04

(52) U.S. Cl. CPC G06K 9/00026; B62D 1/046; G06K 9/0002; G06K 9/0008

(57) ABSTRACT

The present disclosure relates to a fingerprint sensor having a capture surface for capturing characteristic features of the surface of a finger of an operator and an associated analyzing unit, where the analyzing unit and the fingerprint sensor are designed to capture a movement of the characteristic features of the finger across the capture surface; and the analyzing unit is furthermore designed to detect a rotation movement of the finger and to associate a parameter of the rotation movement to a change of a control parameter, as long as the axis of rotation defined by the rotation movement intersects the capture surface.

This application claims priority to the German Application No. 102016119844.7, filed Oct. 18, 2016, now pending, the contents of which are hereby incorporated by reference.

### TECHNICAL FIELD

The present disclosure relates generally to fingerprint sensors, and more specifically to a fingerprint sensor having a sensor surface configured to detect rotation movement of a finger.

### BACKGROUND

Fingerprint sensors are generally used to personalize a man-machine interface. By way of a man-machine interface machines, i.e. the motor vehicle, may be operated. For this, they may especially comprise input means, for example in the form of buttons, touch screens, touch pads and/or the like. Moreover, a man-machine interface of a motor vehicle commonly comprises a steering wheel, configured to accept steering inputs for controlling transversal dynamics of the motor vehicle. Additionally, man-machine interfaces of motor vehicles may comprise display devices, by which responses to operating instructions, guidelines for operating and/or information for a user of the motor vehicle may be provided.

It is known to personalize man-machine interfaces of motor vehicles, such that a design and/or an appearance of the man-machine interface is differently designed for different users. German Application DE 10 2005 042 830 A1 relates to a device and a process for user-specifically setting in-vehicle functions and/or devices, wherein, for at least one user, one respective user-specific data set that contains at least a personal user profile of the user is storable in the memory of an in-vehicle computing unit and/or is storable in a portable storage unit; the user is identifiable by at least a personal identifier; in-vehicle functions and/or devices are automatically customizable by way of the personal user profile and at least the portion of the user-specific data set comprising the personal user profile is encodable and is only decodable following successful identification of the user, which is done by the personal identifier. By way of appropriate devices, especially biometric identification of the user is done. The devices comprise for example a scanner for scanning fingerprints.

German Application DE 199 41 947 A1 relates to operating elements for a combination instrument and a central display, wherein the operating elements are incorporated into a steering wheel of the motor vehicle, wherein the operating element for the central display is arranged on the half of the steering wheel facing the central display and the operating element for the combination instrument is arranged on the half of the steering wheel facing the combination instrument.

Moreover, fingerprint sensors are employed for the cursor control, in order to control a cursor on an electronic display.

It is furthermore known to input rotation gestures by applying several fingers (multitouch) onto a touch-sensitive input surface, and that they are recognized as such by an analyzing unit. Disadvantageously, this requires a comparably large available installation space for the input surface, and in addition, these multitouch gestures hardly resemble the input that is recognized by the user, who is used to operate conventional rotary actuators.

In view of the foregoing, there is a need for a solution allowing input rotation gestures by the use of an input device requiring minimum available space.

### SUMMARY

This object is solved by a fingerprint sensor according to claim 1 or a man-machine interface according to claim 4, respectively. An equally advantageous use as well as an appropriate input method are the object of the independent claims. Advantageous embodiments are the respective object of the dependent claims. It is to be noted that the characteristics individually set forth in the claims may be combined with each other in any technologically reasonable manner featuring further embodiments of the present disclosure. The description, especially in association with the figures, additionally characterizes and specifies the present disclosure.

The present disclosure relates to a fingerprint sensor having a capture surface for capturing characteristic features of a finger, for example a fingerprint of the finger, of an operator, and an associated analyzing unit. The fingerprint sensor, also called fingerprint scanner or fingerprint sensor, comprises a generally planar capture surface for laying-on and capturing a fingerprint of a finger of an operator. For example, it is a fingerprint sensor that is suitable for capturing a print of the finger, especially the papillary lines thereof, at least in certain areas. This fingerprint sensor is also called fully automated fingerprint sensor. There is a large number of methods that may be used for scanning the papillary lines according to the present disclosure, including the following: optical sensors, E-field sensors, polymer TFT sensors (TFT—Thin Film Transistor), thermal sensors, capacitive sensors, contactless 3D sensors and ultrasound sensors.

The fingerprint sensor according to the present disclosure, as a specific form of a biometric sensor, refers to the hardware component of a biometric system, which initially provides the biometric measuring data. It furthermore comprises an analyzing unit. Depending on the biometric method used, the most different types of sensors may be made use of according to the present disclosure: The optical sensors use light for image capturing of the fingerprint. The E-field sensor measures the local variation of the electrical field that is generated on the finger surface texture when emitting a small electrical signal. The polymer TFT sensor measures the light that is emitted when laying on the finger in the polymer substrate, where a touch occurs. The thermal sensor records the thermal image of the laid-on finger. In the capacitive sensor the capture surface, together with the finger surface, forms a capacitor, the capacity of which changes depending on the skin texture (ridges and wells). These local changes are measured and, due to their characteristic features, represent the fingerprint. According to the present disclosure, it is preferred to use an optical or capacitive fingerprint sensor, especially preferred a capacitive fingerprint sensor.

According to the present disclosure, the analyzing unit and the fingerprint sensor are designed to capture a movement of the characteristic features, for example the papillary lines, of the finger, thereby capturing a rotation input of the finger through the capture surface. Besides capturing the fingerprint of the resting finger (scan mode), methods for capturing the finger movement (control mode) are also known. Even though the scan mode, according to the present disclosure, is not necessarily provided, but solely the control mode, embodiments are conceivable, wherein both modes are specifically selected by the operator and/or the analyzing unit. In one configuration, it is provided that the movement is optically detected in the above-mentioned control mode by the speckle interference pattern generated by the fingerprint sensor. It is preferably provided that the movement of the finger, i.e. the associated characteristic features or the fingerprint, respectively, are capacitively measured, as mentioned above.

For example, when capturing characteristic features, in the finger surface touching the capture surface or even entire structures of this surface, for example features associated to the papillary lines, or other individual features of the finger surface are captured and change of position thereof in rotation movement is detected, in order to therefrom derive parameters of the rotation movement, such as angle of rotation and point of rotation. The analyzing unit is thus designed to not only qualitatively detect the rotation movement of the finger, but the parameter belonging to the rotation movement, for example the angle of rotation, the rotation velocity and especially the point of rotation, in order to thereto associate change of a control parameter, as long as the point of rotation defined by the rotation movement is situated within the capture surface, i.e. the associated axis of rotation intersecting the capture surface. In one configuration, this association is exclusively done if the detected point of rotation is within the capture surface.

The axis of rotation or the intersection point thereof with the capture surface, respectively, i.e. the point of rotation, according to the present disclosure, is described by the captured change of position of the papillary lines or the significant structures, such as they are captured following rotational movement or during rotational movement. The person skilled in the art recognizes the respective analyzing methods, and it is furthermore commonly known that not necessarily rotational movement about one single point of all papillary lines and significant structures occurring is required, but statistical analysis and evaluation is required, taking into account, and occasionally taking into account in a weighted manner, the entirety of the significant structures or the entirety of the papillary lines captured. In other word, following analysis, a rotational movement of the fingertip is detected on the capture surface as a type of in-place rotation of the finger, this gesture is associated to a change of a control parameter. For example, a change proportional to the parameter, such as the angle of rotation, of the control parameter is provided. By this, an input is accomplished, requiring little operating surface, and furthermore very much corresponds to that what an operator would consider a possible operating posture during input via a turning knob of a conventional rotary actuator.

Preferably, the analyzing unit is designed to associate to the parameter of the rotation movement of the finger a change of a control parameter, as long as the finger, during the rotation movement, covers the entire capture surface.

The capture surface comprises a surface area of 1 cm² or less.

In one of the above-described embodiments, the present disclosure furthermore relates to a man-machine interface comprising an input device and a fingerprint sensor mounted on the input device.

It is preferred that the input device is a steering wheel. For example, the fingerprint sensor is mounted on the steering wheel rim associated to the steering wheel, the capture surface being integral with the surface of the steering wheel rim. More preferably, the fingerprint sensor is incorporated in a steering wheel spoke of the steering wheel such that the capture surface is incorporated in the surface of the steering wheel spoke, thereby resulting in an especially preferred ergonomic placement for the rotation input, wherein the thumb, as an inputting finger, is safely supported by the steering wheel rim grasped by the index finger, in order to perform the rotation movement required according to the present disclosure.

According to a further configuration of the man-machine interface, the associated input device comprises one or more touch-sensitive input surfaces, such as a touchpad or a touchscreen. The associated fingerprint sensor is arranged such that the capture surface is incorporated into the touch-sensitive input surface, or the capture surface and the input surface are adjacently arranged, for example are arranged adjacently spaced apart from each other. A position-resolving touch detection associated to the input surface may be provided. For example, a capacitive detection of the touch on the input surface as well as a capacitive capturing of the fingerprint on the capture surface by an associated electrode structure is provided. For example, high-resolution electrode structure in the region of the capture surface is provided, whereas in the region of the input surface an electrode structure providing lower position-resolving capacity is sufficient during the touch detection.

The present disclosure furthermore relates to the use of the man-machine interface in one of the above-described embodiments in a motor vehicle.

The present disclosure furthermore relates to an input method by way of fingerprint sensors comprising the following steps. In a provisioning step, providing a fingerprint sensor with a capture surface for capturing characteristic features, for example of a fingerprint, a finger of an operator, and an associated analyzing unit is performed. In a capturing step, capturing the characteristic features, such as of the fingerprint of the finger by way of the fingerprint sensor, moved across the capture surface, and the associated analyzing unit is performed. In a detection step, detection of a rotation movement of the characteristic features and hence the finger with associated parameters, including a point of rotation, through the analyzing unit is performed. In an associating step, association of a parameter of the rotation movement with a change of the control parameter is done, as long as the axis of rotation defined by the rotation movement intersects the input surface. Even here, the following is true: The axis of rotation or the intersection thereof with the capture surface, according to the present disclosure, is described by the detected change of position of the characteristic features, such as the papillary lines or other specific structures of the finger surface, which are dependent on the type of the technology of the fingerprint sensor used, and how they will be captured following rotational movement or during the rotational movement. The person skilled in the art recognizes the associated analyzing methods, and it is furthermore common that herein not necessarily rotational movement of all papillary lines and significant structures occurring around one singular point may be required, but statistical analysis and evaluation is required, taking into account, and occasionally taking into account in a weighted manner, the entirety of the significant captured structures or the entirety of the captured papillary lines. According to the present disclosure, what is necessarily required for the association is the detection of a point of rotation located on the capture surface during rotation input. In other word, following analysis, a rotational movement of the finger tip on the capture surface itself is detected, this gesture being associated to a change of a control parameter. For example, a change of the control parameter is provided that is proportional to the parameter of the rotation input, such as the detected angle of rotation.

According to a preferred configuration of the input method, a change of a control parameter is associated to the parameter of the rotation movement, as long as the finger covers the entire capture surface during the rotation movement and preferably covers the entire capture surface only when covering by the finger is detected.

### BRIEF DESCRIPTION OF THE DRAWINGS

The present disclosure will be explained in detail by way of the following figures.

The figures are only to be understood as an example and solely represent a preferred embodiment, wherein

FIG. 1 shows a man-machine interface with fingerprint sensor during the rotation input by a finger according to an embodiment.

FIG. 2 shows another view of the man-machine interface of FIG. 1.

FIG. 3 shows a sectional view of the man-machine interface of FIG. 1.

FIGS. 4a and 4b show views for clarification of the rotation input according to an embodiment.

FIG. 5 shows a second embodiment of a man-machine interface according to the present disclosure.

FIGS. 6 and 7 show a third embodiment of a man-machine-interface according to the present disclosure.

### DETAILED DESCRIPTION

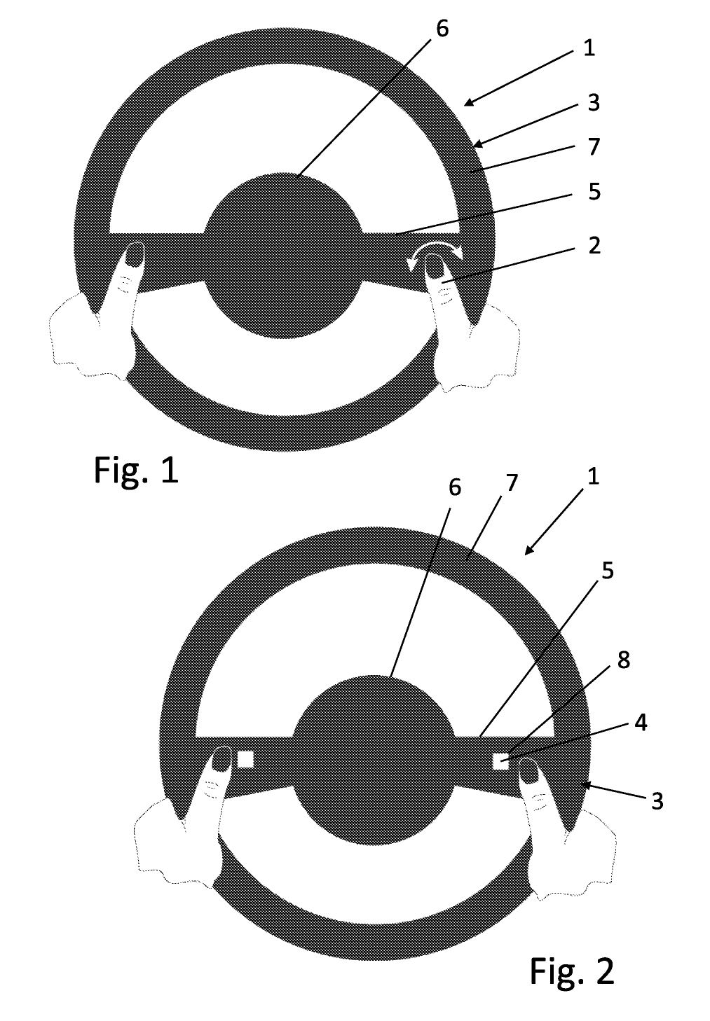

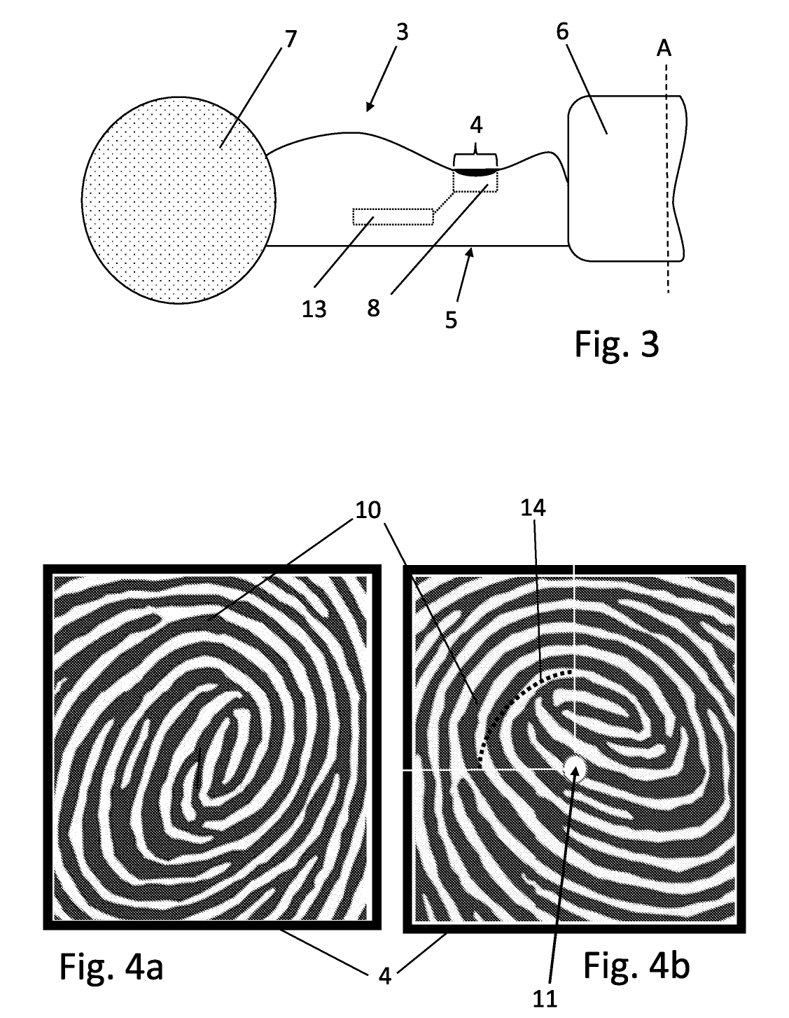

FIG. 1 shows a man-machine interface 1 according to the present disclosure in a motor vehicle not shown in detail. The man-machine-interface 1 according to the present disclosure comprises a steering wheel 3 with an external steering wheel rim 7 and an internal impact absorber 6, which supports the steering wheel rim 4 by means of two diametrically opposing steering wheel spokes 5 . . . . A fingerprint sensor 8 with a capture surface 4 incorporated into the surface of the steering wheel spoke 5 is placed into the steering wheel spokes 5, as it is shown in FIG. 2, the capture surface 4 facing the operator and may be touched, if required, by the finger 2 for input. As shown in FIG. 1, it is possible to cause a change of a control parameter, that is not shown, for example a loudness of the sound output of the vehicle, proportionally to a parameter of the rotation movement, i.e. the rotation input, with the fingerprint sensor 8 according to the present disclosure, by way of a rotation movement of the thumb as a finger 2, the rotation movement being performed on the capture surface 4 with the finger overlapping the capture surface 4, as it is shown in FIG. 1. FIG. 3 shows a schematic sectional view of the steering wheel 3 that is rotatably supported about the axis of rotation A, with fingerprint sensor 8 incorporated into the steering wheel spoke 5, the capture surface 4 thereof being placed in a sink of the surface of the steering wheel spoke 5 for better haptic findability. The fingerprint sensor 8 is electrically connected to an analyzing unit 13 that triggers the capture through the fingerprint sensor 8 and performs the capture of the rotation input, to therefrom determine the rotation movement parameter, including the point of rotation and angle of rotation.

As it is shown in FIGS. 4a and 4b, the focus primarily resides in determination of the parameters, such as the position of the point of rotation 11, which is defined by the position of the axis of rotation during rotation input, and the angle of rotation 14. Accordingly, in FIG. 4a a starting position of the finger and the characteristic features 10 captured by the fingerprint sensor, herein the papillary lines, is shown, whereas FIG. 4b shows a position of the finger realized through the rotation input and hence shows the characteristic features 10 in the capture surface 4. Due to the capture through the analyzing unit it is possible to determine the rotational movement parameter, such as the position of point of rotation 11 and associated angle of rotation 14. Thus, in the case shown, there is a change of a control parameter, the change being proportional to the degree of the angle of rotation, since, as it is shown and as required according to the present disclosure for association, the point of rotation 11 is within the capture surface 4. In the case not shown, wherein the point of rotation is outside the capture surface 4, there would be no change of the pertaining control parameter through the analyzing unit.

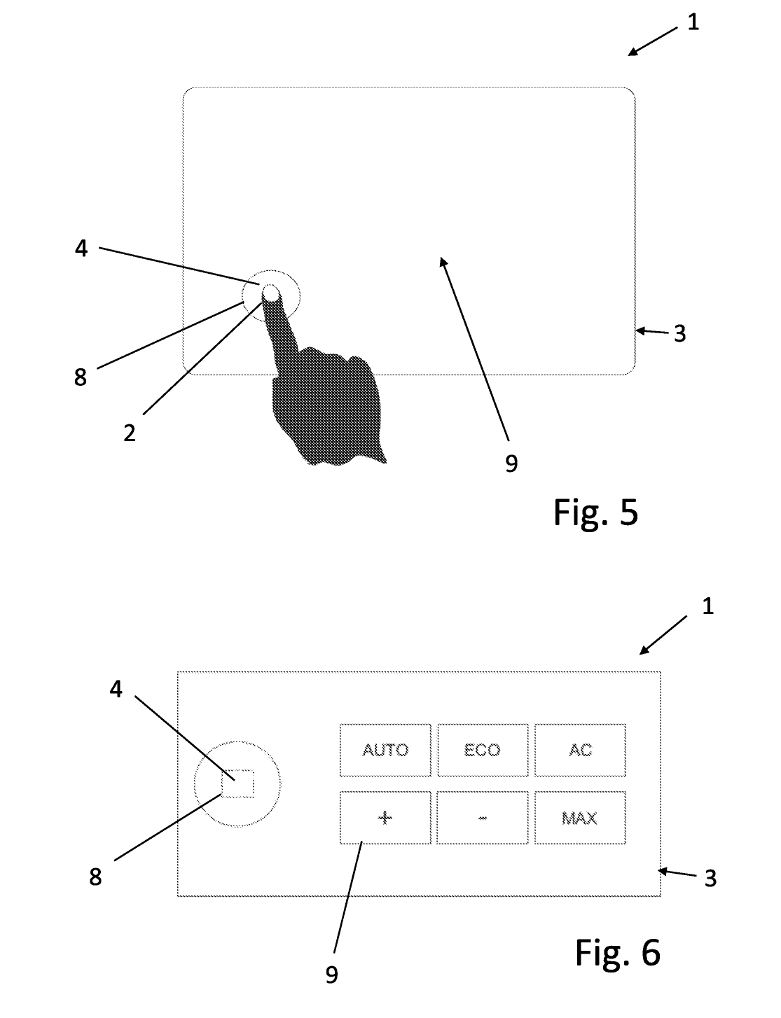

FIG. 5 shows a second embodiment of the man-machine-interface 1 according to the present disclosure, wherein the capture surface 4 of the fingerprint sensor 8 is incorporated into the touch-sensitive input surface 9 of a touchpad 3. For example, position-resolving detection in the range of the input surface 9 as well as in the range of the capture surface 4 is capacitively performed by associated electrode structures, wherein for example higher position-resolving in the range of the capture surface 4 is realized by a locally specific electrode structure that differs from the electrode structure that is associated to the input surface 9.

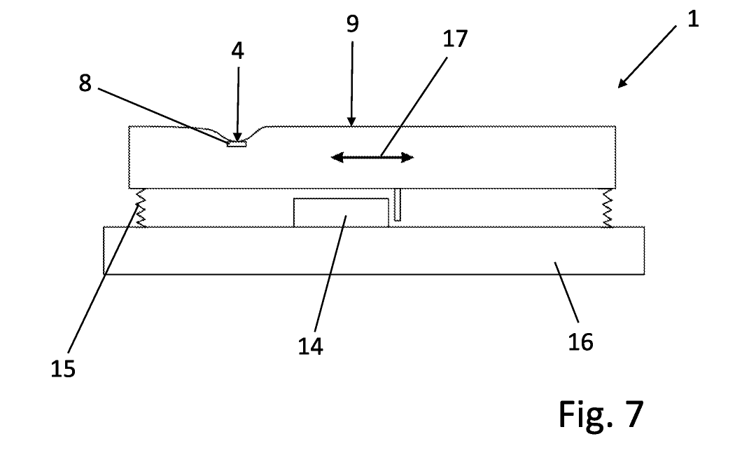

The FIGS. 6 and 7 show a third embodiment of the man-machine interface 1 according to the present disclosure, comprising an input device 3 and a fingerprint sensor 8 mounted on the input device 3. The fingerprint sensor 8 defines a capture surface 4. The input device 3 comprises several touch-sensitive input surfaces 9, the touch of which is capacitively captured. In contrast to the embodiment of FIG. 5, the capture surface 4 is not incorporated into the touch-sensitive input surface 9 but is arranged spaced apart from it. As shown in FIG. 7, the capture surface is arranged in a sink of the surface of the input device 3 facing the operator. Furthermore, the input device 3 is resettingly and movably supported on a housing 16 by springs 15. Furthermore, for creating a haptic feedback during operation an electromagnetic actor 14 is provided, causing a movement excitation corresponding to the arrow 17 of the input device 3 to create the haptic feedback.

1. A fingerprint sensor, comprising:
a capture surface for capturing characteristic features of a surface of a finger of an operator;
an associated analyzing unit, wherein the analyzing unit and the fingerprint sensor are designed to capture a movement of the characteristic features of the finger across the capture surface;
wherein the analyzing unit is further configured to:
detect a rotation movement of the finger and associated parameters, including a point of rotation; and
associate a parameter of the rotation movement to a change of a control parameter, as long as the point of rotation defined by rotation movement and detected by analyzing unit is within the capture surface.

2. The fingerprint sensor of claim 1, wherein the analyzing unit is further configured to: associate the parameter of the rotation movement of the finger to a change of a control parameter, as long as the finger covers the entire capture surface during the rotation movement.

3. The fingerprint sensor of claim 1, wherein the capture surface has a surface area of 1 cm² or less.

4. The fingerprint sensor of claim 1, wherein the fingerprint sensor is mounted to a man-machine interface with an input device and a fingerprint sensor.

5. The fingerprint sensor of claim 4, wherein the input device is a steering wheel.

6. The fingerprint sensor of claim 5, wherein the fingerprint sensor is incorporated into a steering wheel spoke of the steering wheel.

7. The fingerprint sensor of claim 4, wherein the input device defines one or more touch-sensitive input surfaces and the fingerprint sensor is arranged such that the capture surface is at least one of: incorporated into the touch-sensitive input surface, arranged adjacent to the input surface.

8. The fingerprint sensor of claim 4, wherein the fingerprint sensor is installed in a motor vehicle.

9. A method detecting a fingerprint sensor, comprising:
providing a fingerprint sensor with a capture surface for capturing characteristic features of a surface of a finger of an operator, and an associated analyzing unit;
capturing the characteristic features of the finger that has moved across the capture surface by way of the fingerprint sensor and of the associated analyzing unit;
detecting a rotation movement of the finger and associated parameters, including a point of rotation, through the analyzing unit;
associating a parameter of the rotation movement to a change of the control parameter, as long as the point of rotation defined by the rotation movement is situated within the capture surface.

10. The method according to claim 9, wherein the parameter of the rotation movement of the finger is associated to a change of a control parameter, as long as the finger covers the entire capture surface during the rotation movement.
